(19) United States
(12) Patent Application Publication
(10) Pub. No.: US 2021/0272123 A1
(43) Pub. Date: Sep. 2, 2021

(54) PAYMENT-BASED CONFIGURATION TABLE FOR PERFORMING BIOMETRIC VALIDATION OF A USER

(71) Applicant: NexGen Monetization Trust, Newark, DE (US)

(72) Inventor: Christopher John Burke, Central (HK)

(73) Assignee: Global Patent & Assertion Capital Corporation, Newark, DE (US)

(21) Appl. No.: 16/802,939

(22) Filed: Feb. 27, 2020

(51) Int. Cl. G06Q 20/40; G06Q 20/22; G06Q 20/32; G06Q 20/10; G06F 16/22; G06F 9/451

(52) U.S. Cl. CPC G06Q 20/40145; G06Q 20/227; G06Q 20/3224; G06Q 2220/00; G06Q 20/108; G06F 16/2282; G06F 9/451; G06Q 20/3278

(57) ABSTRACT

A computing device has an integrated memory device, which stores a payment-based configuration table identifying a plurality of payment accounts, a biometric template corresponding to each of the plurality of payment accounts, and a biometric database corresponding to biometric data of a user of the computing device. The biometric template identifies one or more biometric modalities based on one or more biometric control parameters. The computing device has a receiver that receives a biometric preference from a payment chain entity. The computing device has a processor that dynamically generates an entry into the payment-based configuration table. The entry identifies a payment account and one of the one or more biometric modalities based upon the biometric preference. The processor generates a user interface having a menu of a plurality of payment account indicia. Each of the plurality of payment account indicia corresponds to one of a plurality of payment accounts.

### BACKGROUND

### 1. Field

This disclosure generally relates to the field of biometric devices. More particularly, the disclosure relates to biometric validation of a user for processing payments.

### 2. General Background

Current payment systems have significantly changed the way in which people provide payments for goods and services. As opposed to the traditional form of payment via a credit card, which has a magnetic stripe that is swiped through a credit card reader, such as at a merchant point of sale (“POS”) terminal, current configurations allow credit card information to be stored directly on a computing device, such as a smartphone of a user.

Yet, many users, financial institutions, and merchants, alike, have expressed hesitation at adopting the use of smartphones for payments. A primary concern for users is security. Although payment data that emanates from the user's smartphone, via wireless communication, may be masked (e.g., via encryption, tokenization, etc.), that user may express hesitation about the possibility of losing his or her smartphone, thereby potentially allowing unintended access by a third-party to the credit/debit card information stored on the smartphone. An additional, and potentially equally important, concern for many users is privacy. As opposed to a plastic credit card, which by itself does not store transaction data, a smartphone may provide instant access to a user's purchase history, as displayed by many banking software applications stored on a user's smartphone. Many users consider their transactions to be private information, not intended to be accessed by third-parties.

Furthermore, many financial institutions and merchants have specific know your customer (“KYC”) requirements that are intended to prevent acceptance of payment from customers whose identity has not been verified by one or more forms of identification. Such KYC requirements help minimize risks for the financial institution and/or merchant. A lost smartphone that is used by an unintended third-party could present KYC compliance issues for the financial institution and/or merchant.

Accordingly, for many users, financial institutions, and merchants, the convenience of mobile payment technology has been outweighed by perceived concerns regarding potential security and privacy risks. Therefore, current payment configurations do not provide adequate safeguards with respect to mobile computing device security and privacy, especially with respect to a lost mobile computing device.

### SUMMARY

In one aspect of the disclosure, a computing device has an integrated memory device, which stores a payment-based configuration table identifying a plurality of payment accounts, a biometric template corresponding to each of the plurality of payment accounts, and a biometric database corresponding to biometric data of a user of the computing device. The biometric template identifies one or more biometric modalities based on one or more biometric control parameters. Furthermore, the computing device has a receiver that receives a biometric preference from a payment chain entity.

Additionally, the computing device has a processor that dynamically generates an entry into the payment-based configuration table. The entry identifies a payment account and one of the one or more biometric modalities based upon the biometric preference. The processor also generates a user interface having a menu of a plurality of payment account indicia. Each of the plurality of payment account indicia corresponds to one of a plurality of payment accounts. Furthermore, the processor receives, via a menu selection user input at the computing device, a menu selection of one of the plurality of payment account indicia. The processor determines a selected biometric modality from the one or more biometric modalities, receives a biometric input of the user, performs biometric validation by comparing the biometric input with the biometric data of the user stored in the biometric database, and transmits, based upon the biometric validation, payment account data to a payee device. The payment account data corresponds to the account associated with the menu selection.

In another aspect of the disclosure, a process may perform the functionality of the computing device. In yet another aspect of the disclosure, a computer program product is provided. The computer program product comprises a non-transitory computer useable storage device having a computer readable program. The computer readable program when executed on the computing device causes the computing device to perform the foregoing process.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1A illustrates an intermediary-based ingestion system that may be used by a computing device to ingest data for generation of the payment-based configuration table.

FIG. 1B illustrates a payee-based ingestion system that may be used by the computing device to ingest data for generation of the payment-based configuration table.

FIG. 2 illustrates a cloud-based system through which the computing device, illustrated in FIGS. 1A and 1B, may implement a software application that utilizes the payment-based configuration table.

FIG. 3 illustrates a system configuration for the computing device, illustrated in FIGS. 1A and 1B.

FIG. 4 illustrates an example of the payment-based configuration table stored by the data storage device of the computing device illustrated in FIG. 3.

FIG. 5 illustrates a payment chain process that filters out one or more biometric modality preferences.

FIG. 6A illustrates invocation of mobile wallet graphical user interface (“GUI”) when the computing device is present within the merchant's store.

FIG. 6B illustrates the mobile wallet GUI rendering a biometric input indicium.

FIG. 7A illustrates invocation of the mobile wallet GUI by the computing device when in proximity to the computing device of the user's friend.

FIG. 7B illustrates the computing device rendering a biometric input indicium.

FIG. 8 illustrates a blockchain configuration.

FIG. 9 illustrates a process 900 that may be utilized by the computing device to transmit data for payment to a payee device, based upon biometric validation.

### DETAILED DESCRIPTION

A payment-based configuration table is provided for performing biometric validation of a user to access payment account data (e.g., user bank accounts, credit card accounts, debit card accounts, cryptocurrency wallet, transaction data, loyalty points/rewards, etc.) at a mobile computing device, and/or transmit payment account data from the mobile computing device. For instance, the payment-based configuration table may have a particular biometric modality (e.g., fingerprint, thumbprint, iris scan, palm scan, facial recognition, etc.) for each of the user's payment accounts stored on the user's smartphone. In one embodiment, a software application is specifically configured to dynamically generate an entry in the payment-based configuration table each time new account information is stored on the user's smartphone; in essence, access to, and/or transmission of, payment account data is restricted from the outset of an account being added to a smartphone, thereby preventing any access or data transmission without biometric validation. Even if a user loses his or her smartphone, all of the account data stored on that smartphone may be secured via biometric validation.

Furthermore, the payment intermediary (e.g., financial institution) and/or payee (e.g., merchant, friend, etc.) may provide one or more biometric control parameters that are added to the payment-based configuration table. In other words, the payment intermediary and/or the payee may meet their own KYC requirements by ensuring that, at a minimum, a biometric modality that meets their KYC requirements is automatically used by the user's smartphone prior to granting access and/or performing payment-associated data transmission. The payee/intermediary biometric control parameter may be an additional biometric modality to that of a user biometric control parameter. For example, a user control parameter for processing a payment transaction may be a thumbprint, whereas the payee control parameter may be facial recognition. Accordingly, prior to the user's smartphone being able to transmit data, the user may have to perform both a thumbprint validation and a facial recognition validation. Alternatively, in another embodiment, the payment-based configuration table may prioritize the more secure biometric modality (e.g., facial recognition as opposed to thumbprint) to only require one biometric validation from the user.

In one embodiment, a computing device (e.g., smartphone, tablet device, smartwatch, smart bracelet, tablet device, smart badge, smart necklace, etc.) may have an integrated proximity-based module (e.g., physical integrated circuit, logical integrated circuit, etc.) that, upon a successful biometric validation according to the payment-based configuration table, activates an integrated proximity-based module. As a result of such activation, the integrated proximity-based module may transmit the payment-associated data, via contactless communication, to a payment device, such as a POS terminal or another computing device, for processing of the transaction. (The term “contactless” is intended to encompass a short distance (e.g., one to ten centimeters) from a device reader, but may permit contact, such as a tap, and may potentially be used with longer distances than ten centimeters. Examples of such contactless communication include, but are not limited to, wireless communication such as Near Field Communication (“NFC”), radio frequency identification (“RFID”), BLUETOOTH, or the like.)

The payment-based configuration table establishes which form of biometric validation of a user is necessary to activate the proximity-based module to release payment-associated data for processing by a proximity-based enabled payment device. For instance, the payment-based configuration table may determine that a fingerprint validation of a user, as dictated by a credit card company for a particular credit card account, is required to send user payment information from a smartphone to a merchant POS terminal, whereas facial recognition is required to send a peer-to-peer payment from the user's smartphone to another user's smartphone in close proximity, based on the biometric validation preference dictated by the other user. Accordingly, the payment-based configuration table provides the capability of biometric validation based on some, or all, of the biometric validation preferences throughout a payment chain of entities (e.g., payor, financial intermediary, and payee), thereby ensuring that all of the biometric validations preferences along that payment chain are met.

In contrast with previous configurations that may have accounted for only one biometric validation preference within the payment chain, the payment-based configuration table may allow for the computing device to have an integrated proximity-based device (e.g., NFC transceiver, RFID transceiver, BLUETOOTH transceiver, etc.) that is activated to transmit user data only upon all biometric validation preferences, or at least prioritized biometric validation preferences that take into account all of the biometric validation preferences in the payment chain, indicated by the payment-based configuration table being met.

Additionally, the payment-based configuration table may also provide for enhanced security. Rather than having various forms of security that run the gamut, depending upon the type of contactless access used by the end-user, the payment-based configuration table allows the computing device to use the same, consistent security mechanism for some, or all, of its contactless communication; what varies is just the biometric validation. In other words, the same secure form of data transmission may be used for different types of payments, even though the forms of biometric validation required to invoke such data transmissions may vary—all from the same computing device. Alternatively, the payment-based configuration table may allow for various forms of secure transmission, but may automatically dictate such variations without the need for user intervention. For example, the computing device may alter the type of encryption used for different types of payments, as dictated by the payment-based configuration table.

In another embodiment, the computing device has a transmitter that is capable of transmitting data to a remote payment device (e.g., a remote server to process an online transaction, remote computing device for peer-to-peer payment, etc.). Furthermore, in this embodiment or other embodiments, the biometric validation may be just one layer of validation that has to be met prior to the computing device releasing payment data, or an instruction sent to another computing device to release payment data, for payment processing. For example, upon successful biometric validation, the computing device may generate a one-time password (“OTP”) that must be entered at the computing device, or a distinct computing device, prior to the computing device, or the distinct computing device, sending payment data to a payee device. Alternatively, the payment account data may be sent after biometric validation, but may not be finalized until receipt of the OTP.

In yet another embodiment, the computing device utilizes the transmitter to record payment transactions, proximity-based or remote, on a blockchain with the particular biometric modalities utilized for the payment transaction. As a result, the blockchain may be monitored, by the payor, intermediary, or payee, to ensure the efficacy of particular modalities and detect fraudulent activity.

In essence, the user is able to utilize one universal payment device for various digital payments, peer-to-peer payments, cryptocurrency exchange, and the like. Furthermore, the user is able to use the universal payment device for either, or both, of proximity-based payments and remote payments.

Moreover, the term “payment” is not limited to use of an actual currency. For example, in some embodiments, the payment-based configuration table may be utilized for redemptions of tokens, rewards, points, etc. earned via various activities (e.g., previous purchases, loyalty programs, gaming participation, etc.). Additionally, the payment-based configuration table may be utilized in a manner that includes a primary payment and one or more secondary payments. For example, a user may provide payment for product with both a credit card, as a primary payment, and loyalty points, as a secondary payment. The payment-based configuration table may assign one biometric modality to both the primary and secondary payments before allowing data for either to be transmitted, locally or remotely, to a merchant; alternatively, it may assign different biometric modalities to the primary and secondary payments, respectively. Finally, the term “payment” may even include a form of exchange of goods or services through a barter program. For example, a first user my provide exchange a first product with a second user for a second product as a barter exchange through a software application. The payment-based configuration table may provide assurance to the first user that the second user is actually the second user, via biometric validation; and vice versa.

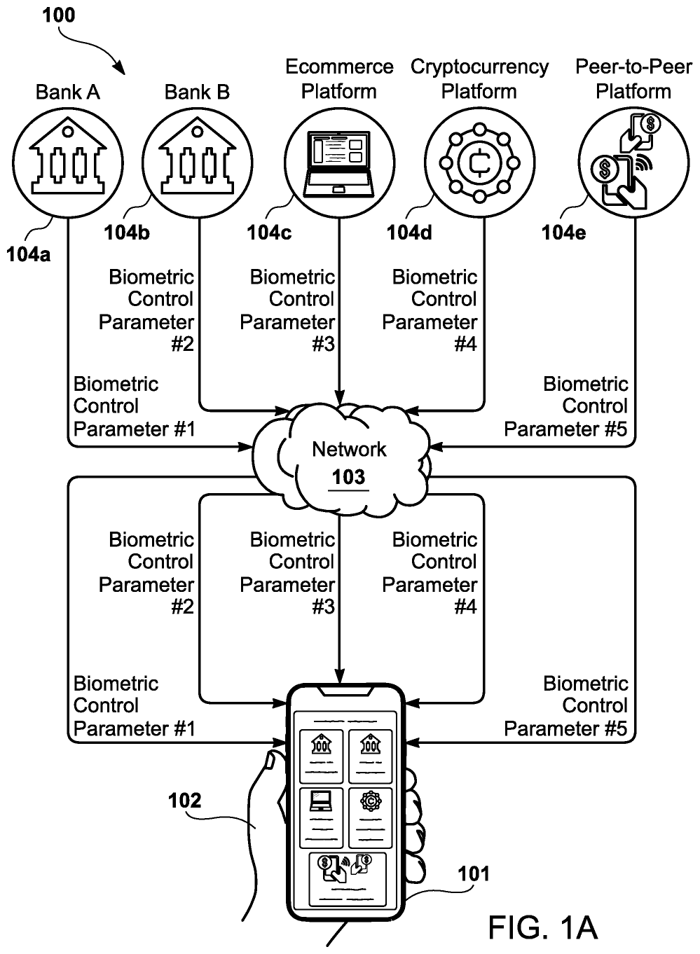

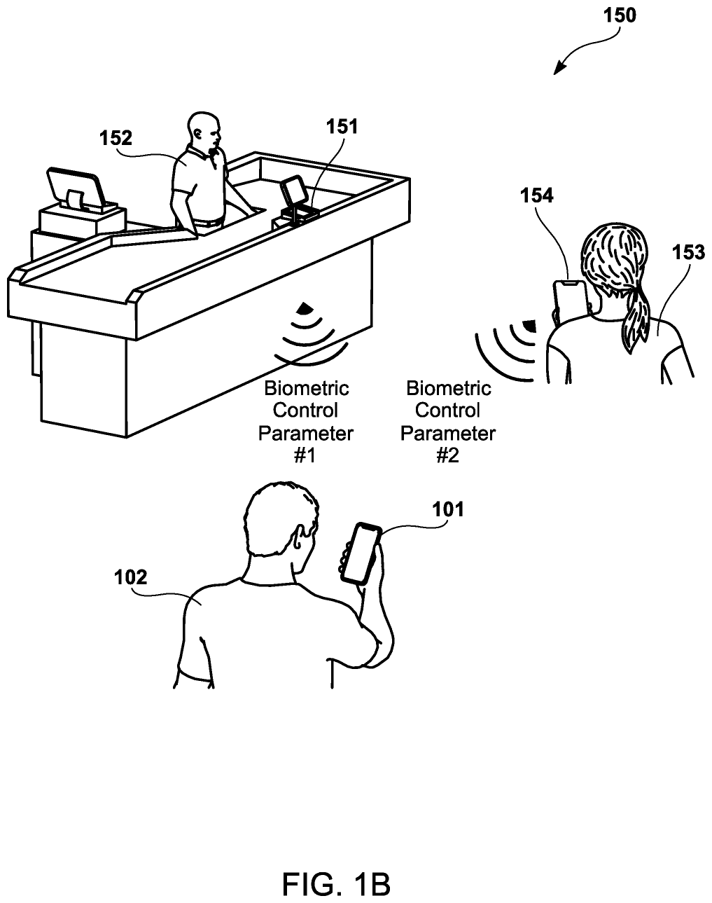

FIGS. 1A and 1B illustrate various configurations of a payment ingestion system. In particular, FIG. 1A illustrates an intermediary-based ingestion system 100 that may be used by a computing device 101 (e.g., smartphone, tablet device, smartwatch, smart bracelet, personal computer (“PC”), laptop, smart apparel, etc.) to ingest data for generation of the payment-based configuration table; in this instance, the particular data ingested includes biometric control parameters (i.e., biometric preferences) from various intermediaries that help facilitate a payment transaction. As examples, FIG. 1A illustrates a plurality of financial intermediaries, such as a first bank 104a, a second bank 104b, an ecommerce platform 104c (e.g., web platform or mobile software application that stores financial data for processing of a transaction), cryptocurrency platform 104d (i.e., web platform or mobile software application that facilitates the exchange of cryptocurrencies), and a peer-to-peer platform 104e (i.e., web platform or mobile software application that facilitates payments between end-users). (The foregoing examples are provided only as examples, given that various other entities (e.g., online brokerages, clearinghouses, escrow companies, credit unions, etc.) may also be utilized to facilitate financial transactions.)

In one embodiment, upon registration (e.g., online, telephone, etc.) of an account with one of the intermediaries 104a-e, the computing device 101 receives, via a network 103, a corresponding biometric control parameter. For instance, the first bank 104a may prefer that the user 102 uses a thumbprint for biometric validation prior to processing of a debit card issued by the first bank 104a; whereas, the second bank 104b may prefer that the user 102 uses a fingerprint for biometric validation prior to processing of a debit card issued by the second bank 104b. In one embodiment, the computing device 101 directly receives the biometric control parameters from the corresponding intermediary, and then dynamically generates and/or updates an entry in the payment-based configuration table. As a result of such dynamic generation, the user 102 and the corresponding intermediary, alike, are assured that the computing device 101 has automatically, and instantly, secured a corresponding payment account via biometric validation on the computing device 101 of the user 102. In another embodiment, a cloud-based configuration (e.g., a server) receives the biometric control parameters from the corresponding intermediary, and then dynamically generates and/or updates an entry in the payment-based configuration table.

To preemptively ensure the security of the computing device 101, the computing device locally stores the actual biometric data (e.g., user thumbprint, user fingerprint, user iris scan, etc.), without transmitting such data external to the computing device 101. Furthermore, in one embodiment, the computing device 101 also locally stores the payment-based configuration table, without transmitting the payment-based configuration table external to the computing device. In an alternative embodiment, the computing device remotely stores the payment-based configuration table, via a cloud-based configuration, at a remotely-situated server. Accordingly, in this embodiment, the server may optimize processing performance of the computing device 101 by performing communication with the intermediaries, as well as dynamic generation of, and/or updates to, entries within the payment-based configuration table. The computing device 101 may then communicate with the remotely-situated server to obtain biometric modalities corresponding to an intermediary as needed.

The intermediaries are illustrated as being remotely situated from the computing device 101. In essence, the intermediary, such as a financial transaction, often will not be physically present at the point of transaction. However, in another embodiment, the intermediary may be potentially present at the point of transaction.

By way of contrast, FIG. 1B illustrates a payee-based ingestion system 150 that may be used by the computing device 101 to ingest data for generation of the payment-based configuration table; in this instance, the particular data ingested includes biometric control parameters from various payees to ensure that the security requirements of a payee are met prior to payment delivery to the payee. As examples, FIG. 1B illustrates a plurality of payees, such as a merchant 152 at a merchant POS terminal 151 and a friend 153 of the user 102 operating a distinct computing device 154. (The foregoing examples are provided only as examples, given that various other entities may also be utilized as payees.)

In one embodiment, the payee-based ingestion system 150 is a proximity-based configuration. In other words, the user 102 (i.e., the payor), may utilize one or more proximity-based devices, integrated within the computing device 101, to detect the presence of a proximity-based device within a payee device within a close proximity (e.g., within a range of zero to ten centimeters) to the computing device 101 and emit payment data (e.g., credit card information) directly, or indirectly via a server configuration, to the payee device upon biometric validation of the user 102; subsequently, the payee device may then utilize the payment data to process the payment from the user 102. For example, the payee device may send the payment account data to the financial intermediary, corresponding to the applicable payment account of the user 102, for processing of payment to the payee by the financial intermediary.

In another embodiment, the payee-based ingestion system 150 is a remote configuration. Accordingly, the user 102 may send payment data, via the network 103 illustrated in FIG. 1A, to a payee device. As an example, the user 102 may send payment data to an online vendor of goods or services. As another example, the user 102 may send payment data to the computing device 154 of his or her friend 153, but through a remote communication. In other words, the user 102 may send payments to his or her friend 153 through the peer-to-peer platform 104e, illustrated in FIG. 1A, without being in proximity to his or her friend 153.

Although the intermediary-based ingestion system 100 and the payee-based ingestion system 150 are illustrated as distinct ingestions systems, they may be implemented together as part of an overall ingestion system. In other words, the payment-based configuration table may be composed of entries for biometric control parameters that are from intermediaries as well as payees. In addition, the biometric control parameters of the user 102 may also be entered within the payment-based configuration table. As a result, all of the biometric preferences of the entities in the payment chain may be entered into the payment-based configuration table so that the biometric validation preferences of all participants in the payment transaction may be considered by the computing device 101 when performing one or more biometric validations of the user 102.

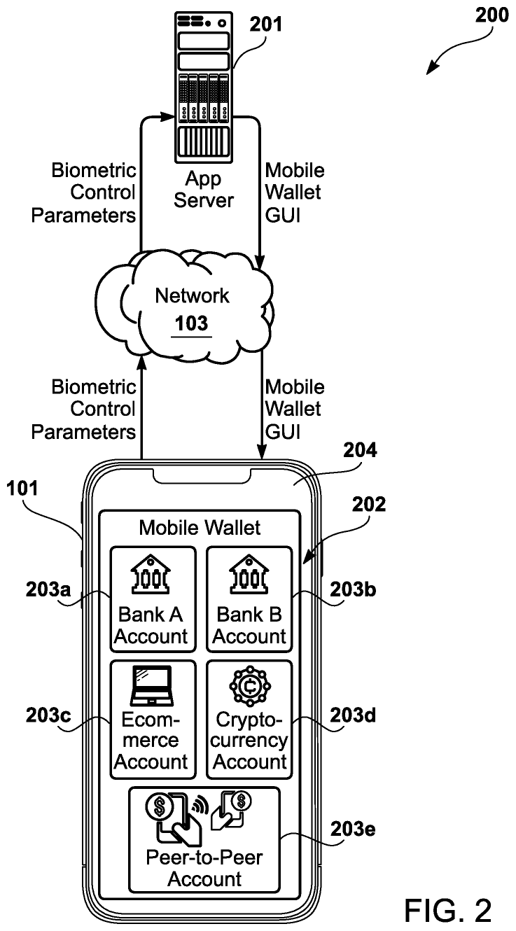

FIG. 2 illustrates a cloud-based system 200 through which the computing device 101, illustrated in FIGS. 1A and 1B, may implement a software application that utilizes the payment-based configuration table. In particular, the computing device 101 may be in operable communication, via the network 103, with an application server 201. For instance, in one embodiment, the computing device 101 provides the biometric control parameters, via the network 103, to the application server 201. In another embodiment, the application server 201 may obtain the biometric control parameters directly from associated entity devices (e.g., payee devices, intermediary devices, etc.). Furthermore, the application server 201 may generate a mobile wallet GUI 202. As an example, the mobile wallet GUI 202 may have various indicia, and associated biometric control parameters, corresponding to the various accounts accessible by the computing device 101. The application server 201 may send the mobile wallet GUI 202 to the computing device 101 for rendering at the computing device 101. For example, the computing device 101 may render the mobile wallet GUI 202 on a display screen 204 to allow the user 102 to select from a menu of different mobile wallet indicia, such as a first bank account indicium 203a, a second bank account indicium 203b, an ecommerce account indicium 203c, a cryptocurrency account indicium 203d, and a peer-to-peer account indicium 203e. The user 102 may then select from the various indicia to activate a particular account for access and/or a payment transaction; prior to such access and/or payment transaction, the computing device 101 may necessitate a biometric validation, as dictated by the biometric control parameters. Although the mobile wallet GUI 202 is illustrated as being received by the computing device 101, in an alternative embodiment, the mobile wallet GUI 202 is generated by the computing device 101.

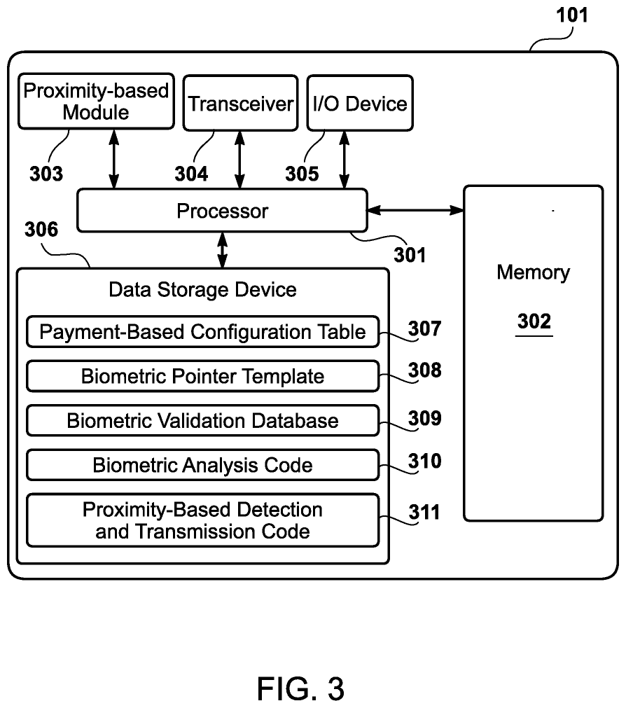

Moreover, FIG. 3 illustrates a system configuration for the computing device 101, illustrated in FIGS. 1A and 1B. A processor 301 may be specialized for data structure generation, biometric operations, and GUI generation.

The system configuration may also include a memory device 302, which may temporarily store data structures used by the processor 301. As examples of such data structures, a data storage device 306 within the system configuration may store a payment-based configuration table 307, a biometric pointer template 308, and a biometric validation database 309. The processor 301 may use the payment-based configuration table 307 to configure a proximity-based module 303, integrated within the computing device 101. For instance, the payment-based configuration table 307 may indicate a particular biometric pointer template 308, which is pointed to with respect to a particular payment account. The biometric pointer template 308 may then indicate a particular modality (e.g., fingerprint, thumbprint, iris scan, facial recognition, etc.) that has to be received from the user 102 for biometric validation for the selected payment account. Upon receiving the corresponding biometric input, the processor 301 may search the biometric validation database 309, which is only stored locally within the computing device 101 for security purposes, to determine whether or not the biometric data inputted by the user 102 matches the biometric data stored in the biometric validation database 309, thereby performing biometric validation of the user 102.

Furthermore, the memory device 302 may temporarily store computer readable instructions performed by the processor 301. For instance, the memory device 302 may temporarily store biometric analysis code 310, which the processor 301 may execute to perform biometric validation. Also, the memory device 302 may temporarily store the proximity-based detection and transmission code 311 to allow the processor 301 to use the proximity-based module 303 to detect the presence of the a proximity-based reader within a payee device and transmit access data, upon biometric validation, to the proximity-based reader 105.

In one embodiment, the proximity-based module 303 is a physical circuit, such as an NFC physical circuit. Upon detecting the presence of an NFC-based reader within a payee device, the NFC-based module 303 awaits an indication of biometric validation from the processor 301, at which time the NFC-based circuit transitions from an open position to a closed position to transmit access data, via magnetic inductive communication, to the NFC-based reader within the payee device. In another embodiment, the proximity-based module 303 is a logical circuit that is implemented via software. Furthermore, the proximity-based module 303 may perform its functionality via two sub-modules, a proximity-based detection module and a proximity-based transmission module, or as one unified module. (The example of NFC is only one example, and is not intended to limit the applicability of the configurations provided for herein to other proximity-based technologies.)

The proximity-based module 303 may be utilized by the computing device 101 with respect to proximity-based payment configurations; however, it is only optional, not necessary, for configurations that are remote payment configurations.

Moreover, the computing device 101 may have one or more input/output (“I/O”) devices 305 that may receive inputs and provide outputs. Various devices (e.g., keyboard, microphone, mouse, pointing device, hand controller, joystick, etc.) may be used for the I/O devices 305. The system configuration may also have a transceiver 304 to send and receive data. Alternatively, a separate transmitter and receiver may be used instead.

Although the system configuration is described with respect to the computing device 101, alternatively, it may be utilized in whole, or in part, by a server, such as the application server 201 illustrated in FIG. 2. For example, the application server 201 may have the processor 301 store the payment-based configuration table 307 in a memory device 302 in the application server 201 to reduce the amount of data stored by the computing device 101, thereby allowing for optimal access by the computing device 101 without providing access to biometric data to the application server 201. (The application server 201 may utilize the various componentry in other ways than those exemplified herein.)

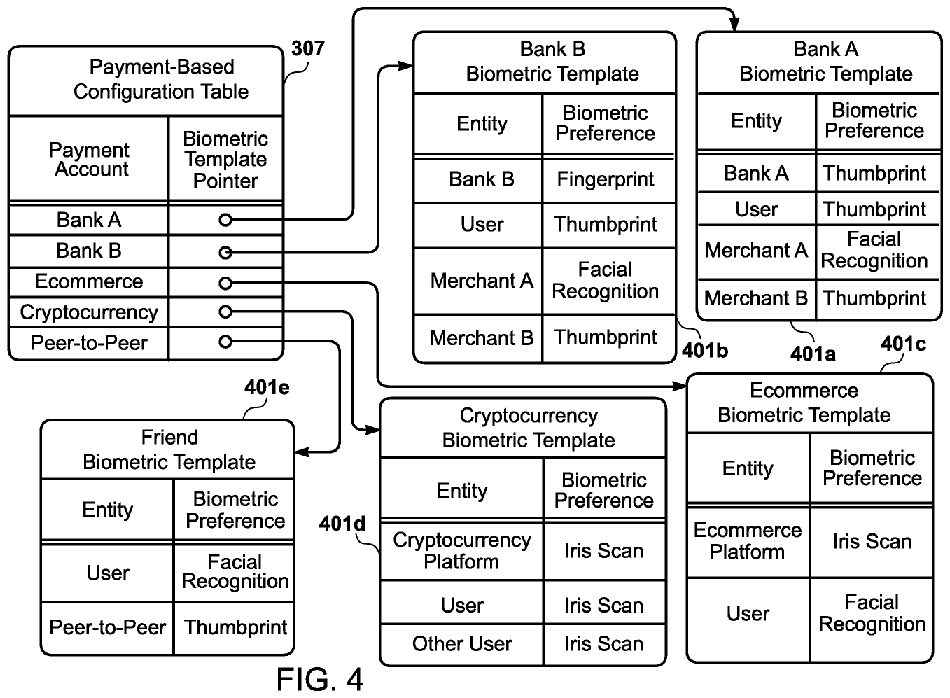

FIG. 4 illustrates an example of the payment-based configuration table 307 stored by the data storage device 306 of the computing device 101 illustrated in FIG. 3. For instance, the payment-based configuration table 307 may have various payment fields that correspond to the mobile wallet GUI indicia 203a-e illustrated, for example, in FIG. 2. As examples, the payment account fields may include a first bank account field, a second bank account field, an ecommerce account field, a cryptocurrency account field, and a peer-to-peer account field. (The foregoing accounts are provided only as examples, given that many other types of account fields may be utilized within the payment-based configuration table 307.) Furthermore, as indicated in the payment-based configuration table 307, each payment account field may have a corresponding biometric template pointer. (For illustrative purposes, visual pointers are illustrated; however, for programmatic purposes, memory addresses or other identifiers may be used in place of the visual pointers.)

As an example, the first bank account payment field may correspond to a first bank biometric template 401a, indicated by the biometric template pointer corresponding to the first bank account payment field. For instance, the first bank biometric template 401a may have various entity fields and corresponding biometric preference fields, which may be populated by the biometric control parameters received during biometric data ingestion by the computing device 101 and/or the application server 201, illustrated in FIG. 2A. For example, the entity fields may indicate the financial intermediary (e.g., the first bank), the payor (e.g., the user 102), and one or more payees (e.g., a first merchant or a second merchant). Each of the entities may have the same or different biometric preferences (e.g., thumbprint, facial recognition, etc.).

As another example, the second bank account payment field may correspond to a second bank biometric template 401b, indicated by the biometric template pointer corresponding to the second bank account payment field. The second bank may have the same or different biometric preferences than the first bank. As other examples, the ecommerce payment field may correspond to an ecommerce biometric template 401c, indicated by the biometric template pointer corresponding to the ecommerce account payment field, the cryptocurrency payment field may correspond to a cryptocurrency biometric template 401d, indicated by the biometric template pointer corresponding to the cryptocurrency account payment field, and the peer-to-peer payment field may correspond to a peer-to-peer biometric template 401e, indicated by the biometric template pointer corresponding to the peer-to-peer account payment field.

In another embodiment, additional fields, or sub-fields, may indicate biometric preferences with a finer level of granularity. For example, the first bank may have different biometric preferences for various actions performed by the user 102. For instance, the first bank may indicate the following biometric preferences for an associated debit card: thumbprint for registering the debit card information, fingerprint for editing the debit card information, iris scan for accessing previous debit card transactions, and facial recognition for processing a debit card transaction.

In yet another embodiment, a biometric preference may be a random biometric modality selection. Accordingly, based on such a biometric preference received from an entity (directly or indirectly), the computing device 101 may randomly select (e.g., via a random number generator (“RNG”)) a biometric modality for the user 102. For example, upon selection of one of the mobile wallet indicia 203a-e from the GUI 202 rendered by the display device 204, the processor 301 of the computing device 101 may perform a random selection, based upon the random selection biometric preference, of the thumbprint biometric input. At a subsequent time, the computing device 101 may randomly select a different biometric modality, such as an iris scan, for the same payment account. Upon a user not being able to perform a biometric validation after a repeated number of tries, the computing device 101 may perform a lockout to prevent further access. Accordingly, an entity is able to effectively minimize fraudulent access and payment processing performed on a given computing device 101 by randomly introducing biometric modalities that are not been relied upon by a nefarious actor.

The foregoing illustrations are intended to emphasize the versatility and applicability of the payment-based configuration table 307. Various other types of payment accounts may be implemented in conjunction with the payment-based configuration table 307. Furthermore, additional or different fields may be implemented within the payment-based configuration table 307. For instance, different encryption requirements may be necessitated for different payment types, and possibly for different biometric modalities within a given biometric template. Also, different transmission requirements (e.g., frequencies) may be necessitated for different payment accounts, and possibly for different biometric modalities within a given biometric template.

The payment-based configuration table 307 allows for improved memory management of the computing device 101. Rather than having to store all of the biometric data in one data structure, the payment-based configuration table 307 may store pointers (e.g., memory addresses) to the biometric pointer templates 401a-e, effectively minimizing the amount of data storage in the computing device 101. As a result, the payment-based configuration table 307 not only allows for payments from a single computing device 101 with universal biometric validation, but also optimizes the efficiency with which data may be retrieved (i.e., faster biometric modality retrieval for a biometric validation request).

In the event that different entities necessitate different biometric modality validation (e.g., intermediary requires iris scan whereas payee requires thumbprint), in one embodiment, all of the different biometric modalities may be necessitated by the computing device 101 to comply with all of the biometric modality requirements of the various entities in the payment chain. In another embodiment, the processor 301 of the computing device 101 is programmed to filter out the biometric modalities that are statistically less secure in favor of the biometric modalities that are statistically more secure. For example, the application server 201 may store up-to-date statistics, which may change on a regular basis, on the security of various biometric modalities. For example, in one week, less incidents of iris scan vulnerabilities may have been determined than other biometric modalities; whereas, in another week, less incidents of facial recognition vulnerabilities may have been determined than other biometric modalities. In yet another embodiment, the processor 301 of the computing device 101 is programmed to randomly select one biometric modality from the various biometric modality preferences of the entities, thereby giving consideration to a biometric modality preference of an entity—even if that particular biometric modality preference is not selected in a given instance.

As an alternative to pointers, data may be stored directly within the payment-based configuration table. In other words, the biometric pointer templates themselves may be stored within the payment-based configuration table.

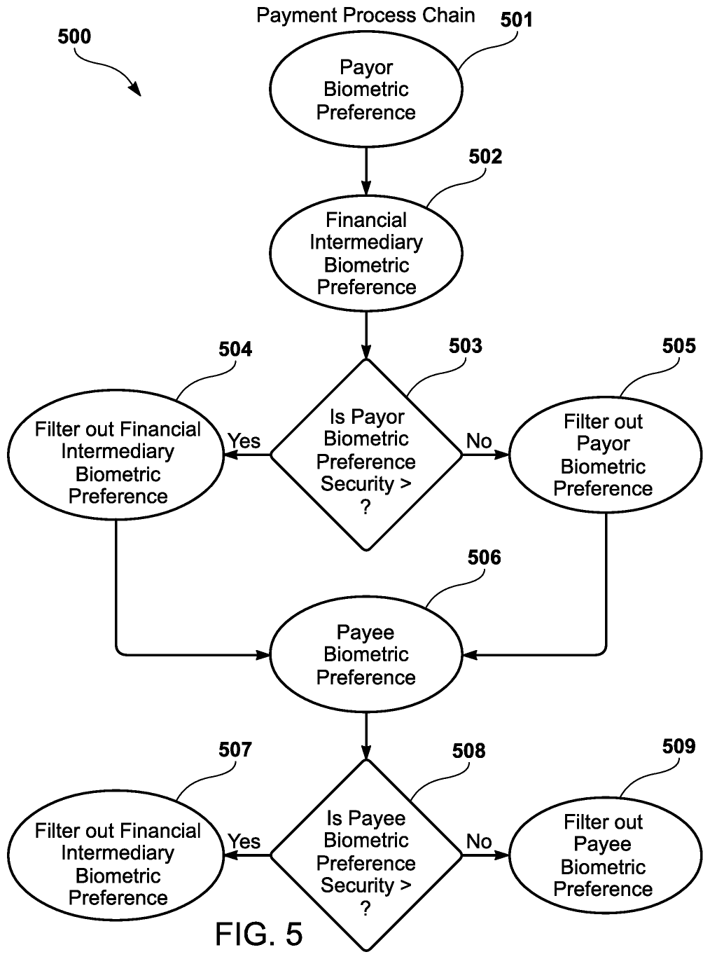

FIG. 5 illustrates a payment chain process 500 that filters out one or more biometric modality preferences. At a node 501, the payment chain process 500 begins with a payor biometric preference. Furthermore, the payment chain process 500 advances to a node 502, encompassing a financial intermediary biometric preference. (In an alternative embodiment, the payment chain process 500 operates such that the node 502 occurs before the node 501, or simultaneously.) At a decision block 503, the payment chain process determines which of the nodes, 501 or 502, has a greater level of security. If the node 501 has greater security, at a node 504, the node 502 is filtered out to leave the node 501 as the biometric modality that is utilized for a given payment access request or payment transaction. Conversely, if the node 502 has greater security, at a node 505, the node 501 is filtered out to leave the node 502 as the biometric modality that is utilized for a given payment access request or payment transaction.

The payment chain process 500 subsequently proceeds to a node 506 encompassing a payee biometric preference. At a decision block 508, the payment chain process 500 determines which of the nodes, 501/502 or 506, has a greater level of security. If the node 506 has greater security, at a node 507, the node 501/502 is filtered out to leave the node 501 as the biometric modality that is utilized for a given payment access request or payment transaction. Conversely, if the node 501/502 has greater security, at a node 509, the node 501/502 is filtered out to leave the node 501 as the biometric modality that is utilized for a given payment access request or payment transaction. (In an alternative embodiment, the payment chain process 500 operates such that the node 506 occurs before the node 501/502, or simultaneously therewith.)

As yet another alternative, the payment chain process 500 is based on additional, or different, factors. For example, the various entities may provide their own prioritizations, which may be utilized by the computing device to filter out biometric modalities.

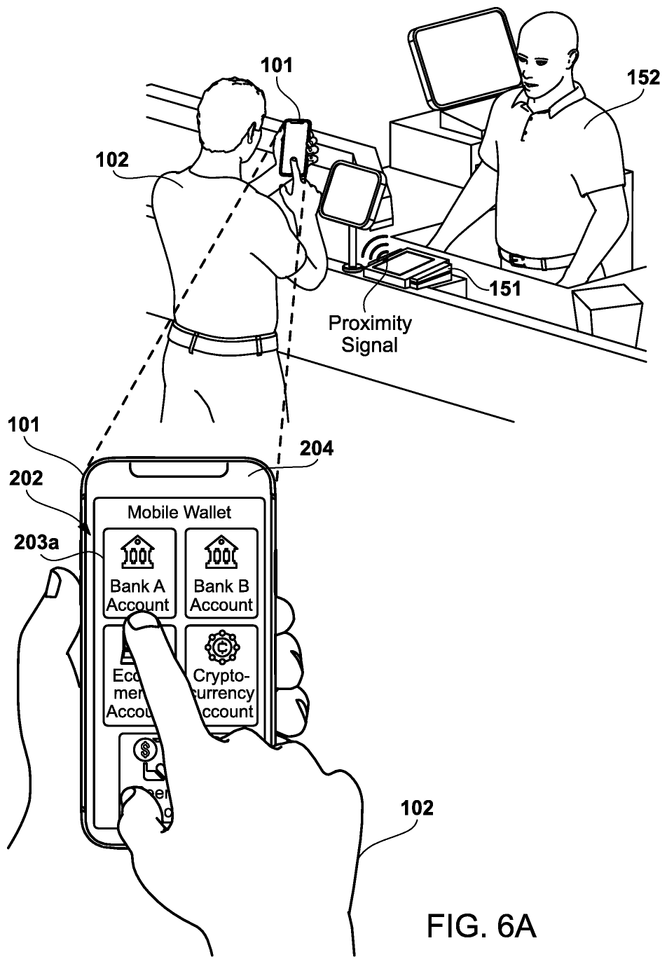

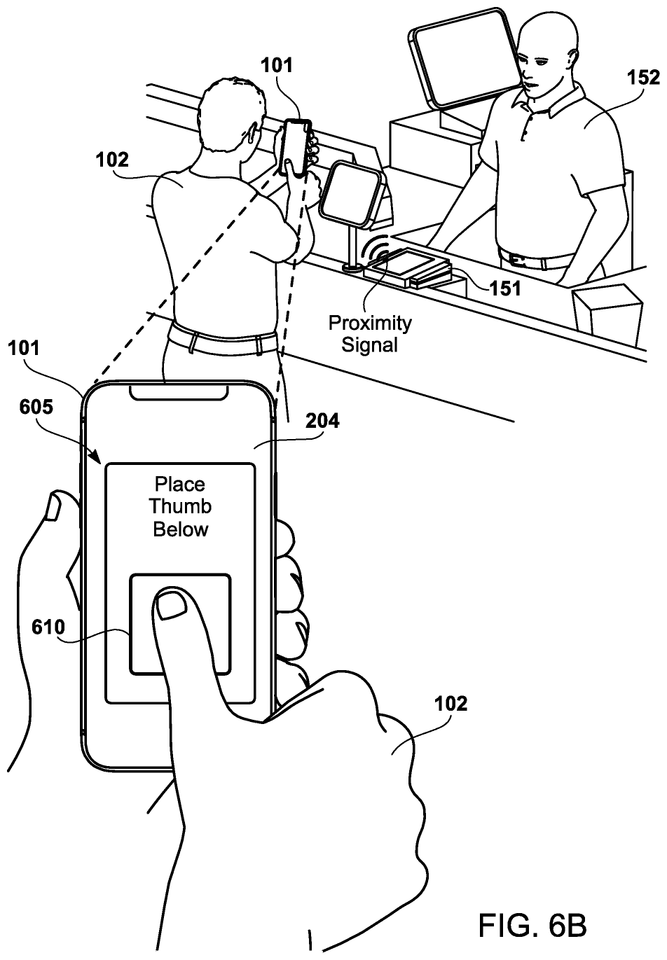

FIGS. 6A and 6B illustrate examples of the computing device 101 being utilized to perform an in-store purchase of products at a merchant's store. In particular, FIG. 6A illustrates invocation of mobile wallet GUI 202 at the computing device 101 within the merchant's store. The merchant may have a POS terminal 151 that emits a proximity signal, which the proximity-based module 303 of the computing device 101 may detect; as a result of such detection, the computing device 101 may receive the biometric preference of the merchant POS terminal 151, and may dynamically add (or update) that biometric preference the payment-based configuration table 307, if necessary. Furthermore, the computing device 101 may invoke the mobile wallet GUI 202 to display the mobile wallet to allow the user 102 to select a particular payment indicium, such as the first bank payment indicium 203a. Furthermore, FIG. 6B illustrates the mobile wallet GUI rendering a biometric input indicium 605. For instance, based on the payment-based configuration table 307, the computing device 101 may determine that a thumbprint is the appropriate biometric modality for processing a payment from the user 102 to the merchant 152, using the first bank account payment data. Accordingly, the biometric input indicium may display a virtual thumbprint pad 610 on which the user 102 may place his or her thumb to provide the thumbprint input. Upon performing biometric validation of the thumbprint of the user 102, the computing device 101 may transmit the first bank account payment data to the merchant POS terminal 151.

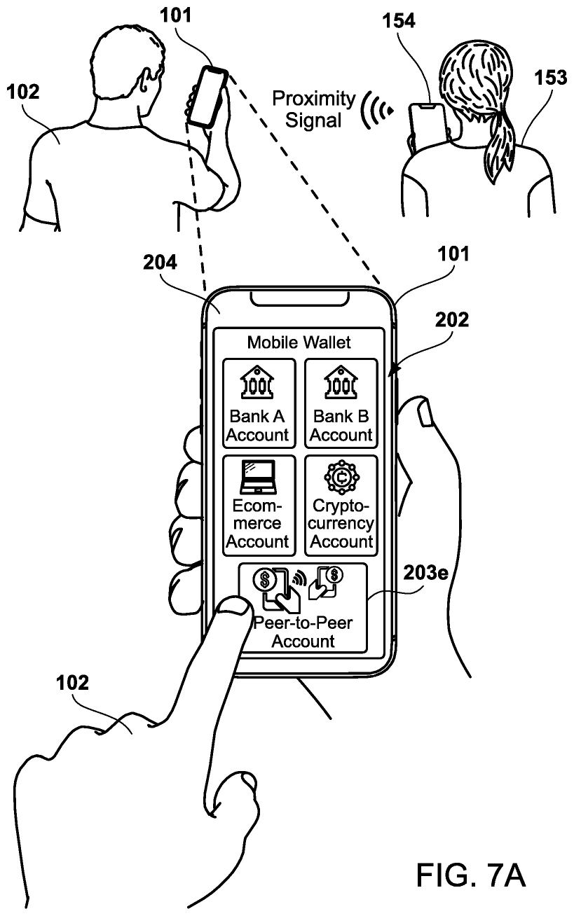

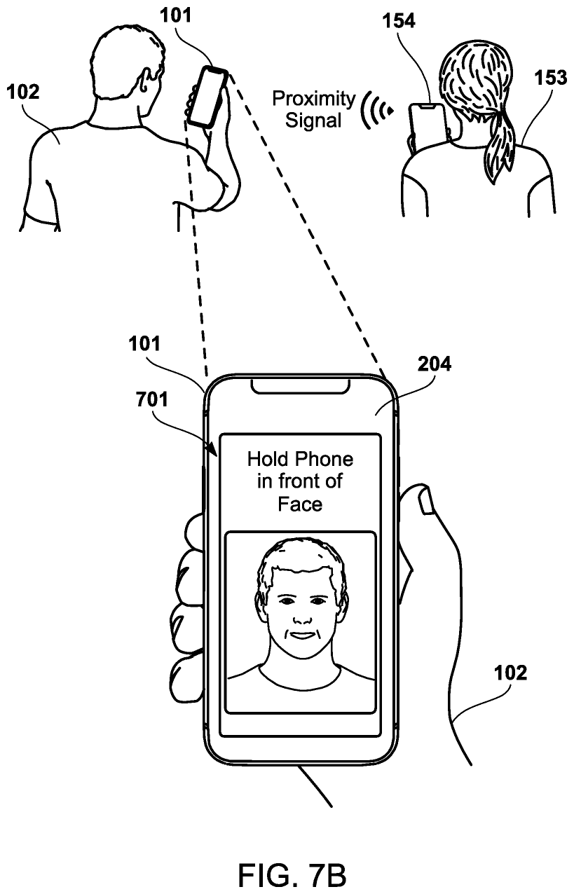

FIGS. 7A and 7B illustrate examples of the computing device 101 being utilized to perform an in-person funds transfer to the computing device 154 of a friend 153 via the peer-to-peer platform 104e, illustrated in FIG. 1A. In particular, FIG. 7A illustrates invocation of the mobile wallet GUI 202 by the computing device 101 when in proximity to the computing device 154 of the friend 153. The computing device 154 of the friend 153 emits a proximity signal, which the proximity-based module 303, illustrated in FIG. 3, of the computing device 101 may detect; as a result of such detection, the computing device 101 may receive the biometric preference of the friend 153, and may dynamically add (or update) that biometric preference to the payment-based configuration table 307, if necessary. Furthermore, the computing device 101 may invoke the mobile wallet GUI 202 to display the mobile wallet to allow the user 102 to select a particular payment indicium, such as the peer-to-peer payment indicium 203e. Furthermore, FIG. 7B illustrates the computing device 101 rendering a biometric input indicium 701. For instance, based on the payment-based configuration table 307, the computing device 101 may determine that facial recognition is the appropriate biometric modality for processing a payment from the user 102 to the merchant 152, using the peer-to-peer account payment data. Upon performing biometric validation of the facial recognition of the user 102, the computing device 101 may transmit the peer-to-peer account payment data to the merchant POS terminal 151.

The peer-to-peer payment platform 104e is not limited to payment transfers to a friend 153 of the user 102. For example, the user 102 may utilize the peer-to-peer payment platform 104e to transfer funds to individuals for goods or services.

Furthermore, although the mobile wallet GUI 202 is illustrated as the GUI for receiving user selections of payment accounts, the configurations provided for herein may be implemented without a mobile wallet. For example, the payment-based configuration table 307 may be configured to work in conjunction with stand-alone software applications, such as bank software applications. An Application Programming Interface (“API”) may be utilized to allow for the stand-alone software applications to access the payment-based configuration table 307. As a result, a biometric validation may be performed via a user's direct access of a stand-alone software application, without a mobile wallet.

Various forms of wired (ETHERNET, cable, etc.), wireless communication (Wi-Fi, BLUETOOTH, etc.), or accessory device transmission (e.g., USB device, disk, etc.) may be utilized to detect the presence of the payor and/or payee devices. Furthermore, although the configurations illustrated in FIGS. 6A-7B depict contactless communication, the computing device 101 may be utilized to generate/receive an OTP that is then utilized by the user 102 to obtain access to a service. For instance, upon performing biometric validation of the user 102, the computing device 101 may display an OTP, which the user 102 may then use to enter at a PC to purchase goods or services from an online vendor.

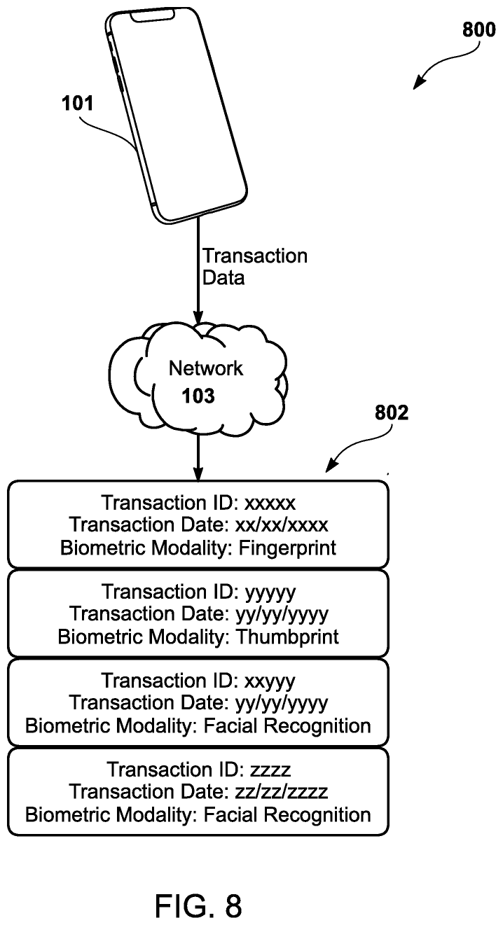

FIG. 8 illustrates a blockchain configuration 800. In one embodiment, upon completion of a transaction, the computing device 101 may record the transaction on a blockchain 802. Furthermore, the computing device 101 may record the particular biometric modality that was validated to complete the transaction. As such, an entity (e.g., payor, intermediary, payee, etc.) may access the blockchain 802 to verify that biometric validation occurred for a particular transaction. And if fraudulent activity was reported for a given transaction, that entity, or another entity, can perform an analysis to determine what led to the fraudulent activity. Furthermore, the blockchain 802 may be utilized to generate statistical samples as to which biometric modality was more secure than others, for a given time period. As a result, the payment chain process 500 illustrated in FIG. 5 may utilize the blockchain 802 to obtain statistical samples for purposes of filtering out less secure, as opposed to more secure, biometric modalities for a given time period.

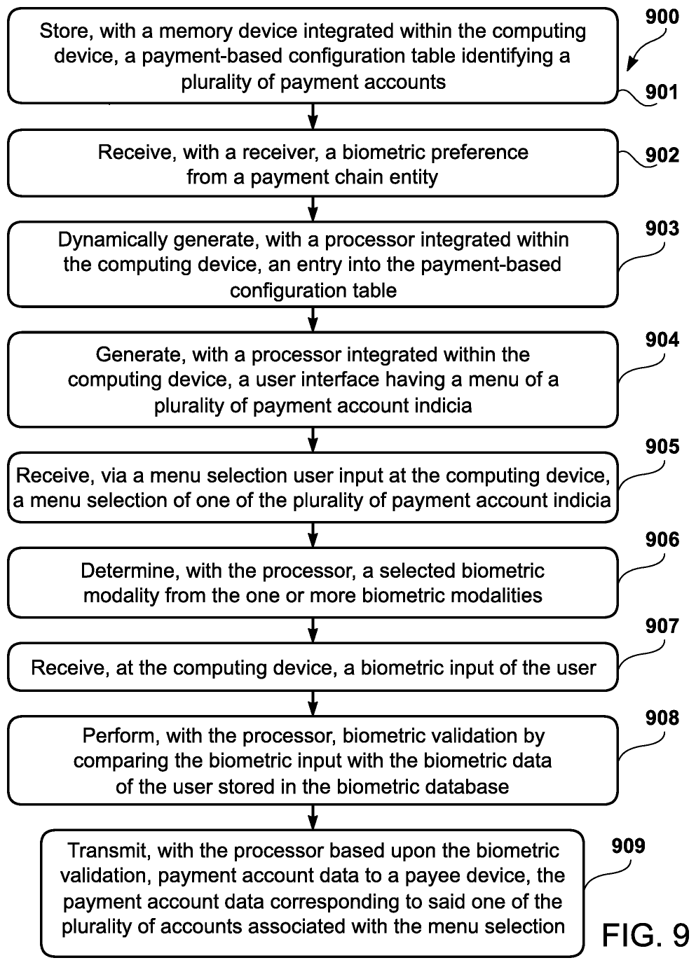

FIG. 9 illustrates a process 900 that may be utilized by the computing device 101 to transmit data for payment to a payee device, based upon biometric validation. At a process block 901, the process 900 stores, with the memory device 302, illustrated in FIG. 3, integrated within the computing device 101, the payment-based configuration table 307 identifying a plurality of payment accounts. A biometric template, such as the biometric pointer template 308, corresponds to each of the plurality of payment accounts, and the biometric database 309 corresponds to biometric data of a user of the computing device 101. The biometric template identifying one or more biometric modalities based on one or more biometric control parameters.

Furthermore, at a process block 902, the process 900 receives, with a receiver, a biometric preference from a payment chain entity, such as, for example, the user 102, an intermediary, or a payee.

At a process block 903, the process 900 dynamically generates, with the processor 301, illustrated in FIG. 3, integrated within the computing device 101, an entry into the payment-based configuration table 307. The entry identifies a payment account and one of the one or more biometric modalities based upon the biometric preference. Furthermore, at a process block 904, the process 900 generates, with the processor 301 integrated within the computing device 101, a user interface having a menu of a plurality of payment account indicia. Each of the plurality of payment account indicia corresponds to one of a plurality of payment accounts. In addition, at a process block 905, the process 900 receives, via a menu selection user input at the computing device 101, a menu selection of one of the plurality of payment account indicia.

Moreover, at a process block 906, the process 900 determines, with the processor 301, a selected biometric modality from the one or more biometric modalities. Prior to, simultaneously with, or subsequently, the computing device 101 receives, at a process block 907, a biometric input of the user 102. At a process block 908, the process 900 performs, with the processor 301, biometric validation by comparing the biometric input with the biometric data of the user 102 stored in the biometric validation database 309. Finally, at a process block 909, the process 900 transmits, with the processor 301, based upon the biometric validation, payment account data to a payee device. The payment account data corresponds to the account associated with the menu selection.

It is understood that the processes, systems, apparatuses, and computer program products described herein may also be applied in other types of processes, systems, apparatuses, and computer program products. Those skilled in the art will appreciate that the various adaptations and modifications of the embodiments of the processes, systems, apparatuses, and computer program products described herein may be configured without departing from the scope and spirit of the present processes and systems. Therefore, it is to be understood that, within the scope of the appended claims, the present processes, systems, apparatuses, and computer program products may be practiced other than as specifically described herein.

I claim:

1. A computer program product comprising a non-transitory computer useable storage device having a computer readable program, wherein the computer readable program when executed on a computing device causes the computing device to:
store, with a memory device integrated within the computing device, a payment-based configuration table identifying a plurality of payment accounts, a biometric template corresponding to each of the plurality of payment accounts, and a biometric database corresponding to biometric data of a user of the computing device, the biometric template identifying one or more biometric modalities based on one or more biometric control parameters;
receive, with a receiver, a biometric preference from a payment chain entity;
dynamically generate, with a processor integrated within the computing device, an entry into the payment-based configuration table, the entry identifying a payment account and one of the one or more biometric modalities based upon the biometric preference;
generate, with a processor integrated within the computing device, a user interface having a menu of a plurality of payment account indicia, each of the plurality of payment account indicia corresponding to one of a plurality of payment accounts;
receive, via a menu selection user input at the computing device, a menu selection of one of the plurality of payment account indicia;
determine, with the processor, a selected biometric modality from the one or more biometric modalities;
receive, at the computing device, a biometric input of the user;
perform, with the processor, biometric validation by comparing the biometric input with the biometric data of the user stored in the biometric database; and
transmit, with the processor based upon the biometric validation, payment account data to a payee device, the payment account data corresponding to said one of the plurality of accounts associated with the menu selection.

2. The computer program product of claim 1, wherein the computing device is further caused to detect, with a proximity-based module integrated within the computing device, proximity to a proximity-based reader positioned within the payee device, the proximity-based reader being positioned externally to the computing device.

3. The computer program product of claim 2, wherein the proximity-based transmission module is an NFC physical circuit.

4. The computer program product of claim 2, wherein the proximity-based transmission module is an NFC logical circuit.

5. The computer program product of claim 1, wherein the computing device is further caused to activate, with the processor based upon the biometric validation, a proximity-based transmission module to perform the transmission of the payment account data.

6. The computer program product of claim 1, wherein the computing device is further caused to perform the transmission of the payment account data via a network, the payee device being remotely situated from the computing device.

7. The computer program product of claim 1, wherein the computing device is further caused to perform the determination of the selected biometric modality from the one or more biometric modalities based upon a statistical analysis of security efficacy amongst the one or more biometric modalities for a given time period.

8. The computer program product of claim 1, wherein the computing device is further caused to perform the determination of the selected biometric modality from the one or more biometric modalities based upon random generation.

9. A process comprising:
storing, with a memory device integrated within the computing device, a payment-based configuration table identifying a plurality of payment accounts, a biometric template corresponding to each of the plurality of payment accounts, and a biometric database corresponding to biometric data of a user of the computing device, the biometric template identifying one or more biometric modalities based on one or more biometric control parameters;
receiving, with a receiver, a biometric preference from a payment chain entity;
dynamically generating, with a processor integrated within the computing device, an entry into the payment-based configuration table, the entry identifying a payment account and one of the one or more biometric modalities based upon the biometric preference;
generating, with a processor integrated within the computing device, a user interface having a menu of a plurality of payment account indicia, each of the plurality of payment account indicia corresponding to one of a plurality of payment accounts;
receiving, via a menu selection user input at the computing device, a menu selection of one of the plurality of payment account indicia;
determining, with the processor, a selected biometric modality from the one or more biometric modalities;
receiving, at the computing device, a biometric input of the user;
performing, with the processor, biometric validation by comparing the biometric input with the biometric data of the user stored in the biometric database; and
transmitting, with the processor based upon the biometric validation, payment account data to a payee device, the payment account data corresponding to said one of the plurality of accounts associated with the menu selection.

10. The process of claim 9, further comprising detecting, with a proximity-based module integrated within the computing device, proximity to a proximity-based reader positioned within the payee device, the proximity-based reader being positioned externally to the computing device.

11. The process of claim 10, wherein the proximity-based transmission module is an NFC physical circuit.

12. The process of claim 10, wherein the proximity-based transmission module is an NFC logical circuit.

13. The process of claim 9, further comprising activating, with the processor based upon the biometric validation, a proximity-based transmission module to perform the transmission of the payment account data.

14. The process of claim 9, further comprising performing the transmission of the payment account data via a network, the payee device being remotely situated from the computing device.

15. The process of claim 9, further comprising performing the determination of the selected biometric modality from the one or more biometric modalities based upon a statistical analysis of security efficacy amongst the one or more biometric modalities for a given time period.

16. The process of claim 9, further comprising performing the determination of the selected biometric modality from the one or more biometric modalities based upon random generation.

17. A computing device comprising:
a memory device integrated within the computing device, the memory device storing a payment-based configuration table identifying a plurality of payment accounts, a biometric template corresponding to each of the plurality of payment accounts, and a biometric database corresponding to biometric data of a user of the computing device, the biometric template identifying one or more biometric modalities based on one or more biometric control parameters;
a receiver that receives a biometric preference from a payment chain entity; and
a processor that dynamically generates an entry into the payment-based configuration table, generates a user interface having a menu of a plurality of payment account indicia receives, via a menu selection user input at the computing device, a menu selection of one of the plurality of payment account indicia, determines a selected biometric modality from the one or more biometric modalities, receives a biometric input of the user, performs biometric validation by comparing the biometric input with the biometric data of the user stored in the biometric database, and transmits, based upon the biometric validation, payment account data to a payee device, each of the plurality of payment account indicia corresponding to one of a plurality of payment accounts, the entry identifying a payment account and one of the one or more biometric modalities based upon the biometric preference, the payment account data corresponding to said one of the plurality of accounts associated with the menu selection.

18. The computing device of claim 17, further comprising a proximity-based module integrated within the computing device, the proximity-based module detecting proximity to a proximity-based reader positioned within the payee device, the proximity-based reader being positioned externally to the computing device.

19. The computing device of claim 17, wherein the proximity-based transmission module is an NFC physical circuit.

20. The computing device of claim 17, wherein the proximity-based transmission module is an NFC logical circuit.
